(19) United States
(12) Patent Application Publication
(10) Pub. No.: US 2015/0320014 A1
(43) Pub. Date: Nov. 12, 2015

(54) Pet Surgical Wrap

(71) Applicant: Sandra Anthony, St. Louis, MO (US)

(72) Inventor: Sandra Anthony, St. Louis, MO (US)

(21) Appl. No.: 14/709,526

(22) Filed: May 12, 2015

Related U.S. Application Data
(60) Provisional application No. 61/991,722, filed on May 12, 2014.

(51) Int. Cl. A01K 13/00

(52) U.S. Cl. CPC A01K 13/006

(57) ABSTRACT

A pet surgical wrap for covering a pet's wound or the location of an incision. The pet surgical wrap comprises an elongated sheet having a front end, a rear end, a first side, and a second side. Preferably, the elongated sheet has a trapezoidal configuration, such that the elongated sheet tapers from the front end towards the rear end thereof. The first side and second side of the elongated sheet include mating fasteners thereon, wherein the mating fasteners can be overlapped so as to secure the pet surgical wrap in a loop around a pet's torso. The interior surface of the elongated sheet includes a pad thereon for covering the wound or incision when the surgical wrap is disposed around the pet's body.

### CROSS REFERENCE TO RELATED APPLICATION

This application claims the benefit of U.S. Provisional Application No. 61/991,722 filed on May 12, 2015. The above identified patent application is herein incorporated by reference in its entirety to provide continuity of disclosure.

### BACKGROUND OF THE INVENTION

### Field of the Invention

The present invention relates to surgical wraps. More specifically the invention relates to a surgical wrap for a pet adapted to be worn around a pet's torso so as to cover a pet's wound or incision, preventing the pet from biting, licking, or scratching the same. The pet surgical wrap comprises an elongated sheet that can be disposed in a loop and secured around the pet's torso so as to cover the wound or incision.

Animals and pets often bite, lick or scratch their wounds and incisions from medical procedures. As a result, the pets may introduce germs and bacteria into the wound or incision. Further, the pet may exacerbate the wound or may reopen the incision, increasing the damage and risk of harm to the pet. Pets may also bite the stitches on their incisions, causing the incision to reopen. Interfering with a wound or incision may slow the healing process and may cause further damage or injury to the pet.

While some pet owners utilize cones that can be removably positioned around the pet's head for preventing the pet from biting or licking a wound or incision, such devices can be uncomfortable and unwieldy. The pet may be unable to rest comfortably and may further be unable to eat and drink in the usual manner. Further, the cones may obscure or limit the pet's vision. Thus, the use of cones is problematic and undesirable as the cones tend to interfere with the animal's daily activities. Thus, a device for covering a pet's incision or wound so as to prevent the pet from biting or licking the same is desired.

### SUMMARY OF THE INVENTION

In view of the foregoing disadvantages inherent in the known types of pet surgical wraps now present in the prior art, the present invention provides a new pet surgical wrap wherein the same can be utilized for providing convenience for the user when covering a pet's wound or incision so as to prevent the pet from biting, licking, or scratching the same.

It is therefore an object of the present invention to provide a new and improved surgical wrap device that has all of the advantages of the prior art and none of the disadvantages.

It is another object of the present invention to provide a surgical wrap that can be used to cover a pet's torso and any wounds or incisions thereon.

Another object of the present invention is to provide a pet surgical wrap that comprises an elongated sheet having a trapezoidal shape that tapers from a front end to a rear end thereof so as to fit along the tapering shape of a pet's torso.

Another object of the present invention is to provide a surgical wrap comprising an elongated sheet having a first end opposite a second end, wherein mating fasteners are positioned on the first end and second end such that the elongated sheet can be formed into a loop around the pet's torso.

Another object of the present invention is to provide a pet surgical wrap comprises a pad on an interior surface thereof adapted to contact a wound or incision.

Yet another object of the present invention is to provide a surgical wrap that is composed of a flexible material so as to snugly fit pets of various sizes.

An additional object of the present invention is to provide a pet surgical wrap that may be readily fabricated from materials that permit relative economy and are commensurate with durability.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a view of the interior surface of the pet surgical wrap of the present invention.

FIG. 2 shows a perspective view of the pet surgical wrap as positioned on a pet's body.

### DETAILED DESCRIPTION OF THE INVENTION

Reference is made herein to the attached drawings. Like reference numerals are used throughout the drawings to depict like or similar elements of the pet surgical wrap. For the purposes of presenting a brief and clear description of the present invention, the preferred embodiment will be discussed as used for placement around the torso of an animal in order to protect a wound from becoming contaminated after surgery and/or injury thereto. The figures are intended for representative purposes only and should not be considered to be limiting in any respect.

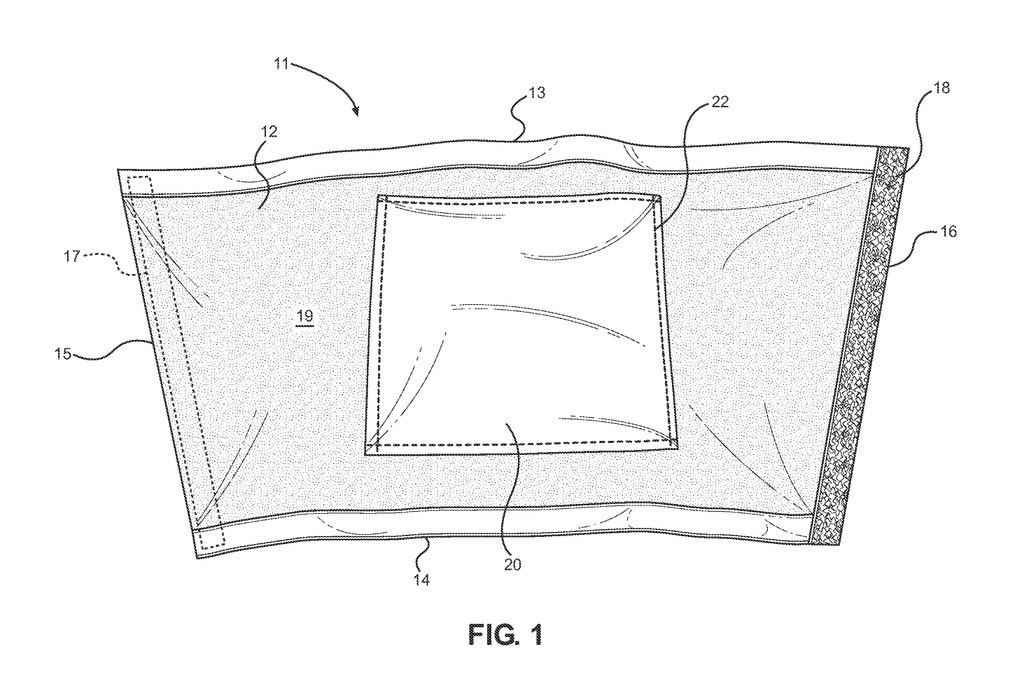

Referring now to FIG. 1, there is shown a view of the interior surface of the pet surgical wrap of the present invention. The pet surgical wrap 11 comprises an elongated sheet 12 having a front end 13, a rear end 14, a first side 15 and a second side 16 opposite said first side 15. The elongated sheet 12 preferably comprises a trapezoidal shape, wherein the elongated sheet 12 tapers from the front end 13 towards the rear end 14 thereof. In this way, the elongated sheet 12 comprises a wider front end 13 relative to the rear end 14. This helps the elongated sheet 12 to fit to the curvature or tapering shape of an animal's torso.

The elongated sheet 12 is preferably compose of a flexible material such that that elongated sheet 12 can stretch to fit around the torsos of animals of various sizes. The elongated sheet 12 of the pet surgical wrap 11 can be composed of soft materials such as fleece, cotton, polyester, neoprene, nylon, spandex, wool, terrycloth and/or other suitable materials. The elongated sheet 12 can be composed of a material that is machine-washable and reusable so that the pet owner can continually use the pet surgical wrap 11 and can clean the pet surgical wrap 11 as needed.

The first side 15 and second side 16 of the elongated sheet 12 include mating fasteners 17, 18 thereon that are adapted to be engaged in an overlapping relation so that the elongated sheet 12 is configured in a loop. The first side 15 comprises a first fastener 17 on an exterior surface of the elongated sheet 12 and the second side 16 comprises a second fastener 18 on the interior surface 19 of the elongated sheet 12. Preferably, the fasteners 17, 18 comprise hook and loop fastening material, however, other types of fasteners may be used in alternate embodiments such as buttons or snaps, among others.

The interior surface 19 of the elongated sheet 12 further comprises a pad 20 thereon. The pad 20 is adapted to cover the wound or incision on the pet's body. The pad 20 is composed of an absorbent material, such as gauze or cotton, among others. In the illustrated embodiment, the pad 20 comprises a square configuration and is positioned centrally on the interior surface 19 of the elongated sheet 12. However, in alternate embodiments, the pad 20 can substantially cover the entirety of the interior surface 19. The pad 20 is substantially planar, comprising a thin sheet-like structure, however the pad 20 can be cushioned in an alternative embodiment to provide comfort to the body of the animal or human to which it is applied. The pad 20 is preferably permanently affixed to the interior surface 19 of the elongated sheet 12 such that the pad 20 is flush thereagainst. The pad 20 can be secured thereto via stitching 22 as shown in the illustrated embodiment, or by use of adhesives.

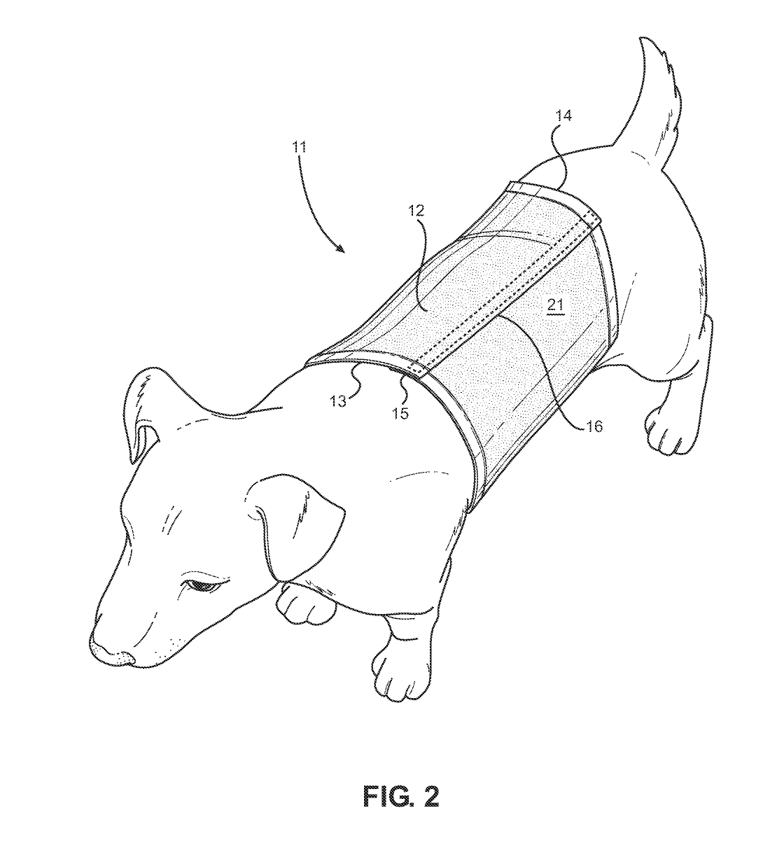

Referring now to FIG. 2, there is shown a perspective view of the pet surgical wrap as positioned on a pet's body. In operation, the user can wrap the elongated sheet 12 of the pet surgical wrap 11 around the torso of a pet such that the front end 13 is arranged adjacent the pet's front legs, and the rear end 14 is disposed adjacent to the pet's rear legs. The front end 13 is wider than the rear end 14 such that the pet surgical wrap 11 tapers towards the rear of the pet's body when disposed on the pet's body. The pad disposed on the interior surface of the pet surgical wrap 11 is preferably placed in contact with the pet's wound or incision so as to provide cushioning or padding thereto, and so as to absorb any moisture or discharge from the wound or incision.

The mating fasteners disposed on the first and second sides 14, 15 of the elongated sheet 12 are secured in an overlapping configuration so that the elongated sheet 12 forms a loop around the pet's torso. The elongated sheet 12 is preferably composed of a flexible material so that the pet surgical wrap 11 can be fitted snugly onto pets of various sizes. The pet surgical wrap 11 can be easily removed as desired by the user, and the pet surgical wrap 11 can be cleaned and reused.

Thus, the present invention provides a pet surgical wrap 11 that can be removably positioned around a pet's torso so as to cover a wound or incision, preventing the animal from biting, licking, or scratching the same. A pad composed of an absorbent material is disposed on the interior surface of the elongated sheet of the pet surgical wrap and is adapted to be placed in contact with the wound or incision. The pet surgical wrap 11 can be adjustably and removably positioned around a pet's torso so that the pet is unable to remove the same.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A pet surgical wrap for covering a pet's torso, comprising:
an elongated sheet comprising a front end, a rear end, a first side, and a second side opposite said first side;
a pad disposed on an interior surface of said elongated sheet;
a first fastener disposed on said first side of said elongated sheet and a second fastener disposed on said second side of said elongated sheet, wherein said first fastener and said second fastener are removably engageable so as to configure said elongated sheet in a loop about a pet's torso.

2) The pet surgical wrap of claim 1, wherein said elongated sheet comprises a trapezoidal configuration wherein said elongated sheet tapers from said front end towards said rear end.

3) The pet surgical wrap of claim 1, wherein said elongated sheet is composed of a flexible material.

4) The pet surgical wrap of claim 1, wherein said pad is composed of an absorbent material.

5) The pet surgical wrap of claim 1, wherein said first fastener and said second fastener comprise hook and loop fastening material.

6) The pet surgical wrap of claim 1, wherein said first fastener is disposed on a rear surface of said elongated sheet and wherein said second fastener is disposed on a front surface of said elongated sheet.

7) The pet surgical wrap of claim 1, wherein said pad is stitched onto said interior surface of said elongated sheet.
